(19) United States
(12) Patent Application Publication
(10) Pub. No.: US 2023/0038779 A1
(43) Pub. Date: Feb. 9, 2023

(54) RODENT CONTROL FEED MIXTURE AND METHODS OF MANUFACTURE AND USAGE THEREOF

(71) Applicant: Guy Richard Coldwell, Strathmore (CA)

(72) Inventor: Guy Richard Coldwell, Strathmore (CA)

(21) Appl. No.: 17/874,754

(22) Filed: Jul. 27, 2022

(30) Foreign Application Priority Data
Aug. 3, 2021 (CA) 3126651

(51) Int. Cl. A01N 63/32; A01N 25/08; A01P 11/00

(52) U.S. Cl. CPC A01N 63/32; A01N 25/08; A01P 11/00

(57) ABSTRACT

A rodent control mixture includes a blended chewing gum, salt, fast rising yeast, and flavor additive such as alfalfa powder. The blended chewing gum may be a spearmint-flavored Chiclets chewing gum blended into a powdered form. Relative weights of ingredients of the rodent control feed mixture include two weight units of the powdered gum, two weight units of the salt, one weight unit of the fast-rising yeast, and one weight unit of the flavor additive. A rodent control feed is formed by mixing the rodent control mixture with water and oil into a rodent food such as rolled oats. The rodent control feed is then placed into the burrow holes of the target rodent such as into gopher holes of a gopher burrow. Beneficially, the rodent control mixture and associated feed is less harmful to humans, domestic animals and wildlife than poisons such as Strychnine commonly utilized to kill rodents.

### CROSS-REFERENCE TO RELATED APPLICATIONS

This application claims the benefit of priority of Canadian Patent Application No. 3,126,651 filed Aug. 3, 2021, which is incorporated herein by reference.

### BACKGROUND OF THE INVENTION

### (1) Field of the Invention

The invention pertains generally to controlling small rodents such as gophers in fields. More specifically, the invention relates to rodent control mixtures, feeds created therefrom and methods of manufacture and usage thereof.

### (2) Description of the Related Art

Strychnine is a strong poison that has historically been utilized for killing small rodents such as gophers that make unwanted burrows in farmers' fields. Although effective, applying poison in outside environments such as farm fields to kill rodents is dangerous both to humans, domesticated animals that utilize the fields, and to other wild animals such as hawks that feed on said rodents. For these reasons, certain areas have ceased allowing strychnine to be sold for purposes of rodent control.

### BRIEF SUMMARY OF THE INVENTION

According to an exemplary embodiment of the invention there is disclosed a mixture of natural ingredients (no poison) mixed with oats (seed and rolled) that controls rodents.

According to an exemplary embodiment of the invention there is disclosed a rodent control mixture including a blended chewing gum, salt, fast rising yeast, and flavor additive such as alfalfa powder. The blended chewing gum may be a spearmint-flavored Chiclets chewing gum blended into a powdered form. Relative weights of ingredients of the rodent control feed mixture include two weight units of the powdered gum, two weight units of the salt, one weight unit of the fast-rising yeast, and one weight unit of the flavor additive. A rodent control feed is formed by mixing the rodent control mixture with water and oil into a rodent food such as rolled oats. The rodent control feed is then placed into the burrow holes of the target rodent such as into gopher holes of a gopher burrow. Beneficially, the rodent control mixture and associated feed is less harmful to humans, domestic animals and wildlife than poisons such as Strychnine commonly utilized to kill rodents.

According to an exemplary embodiment of the invention there is disclosed a rodent control mixture including a plurality of blended chewing gum, a plurality of salt, a plurality of fast rising yeast, and a flavor additive.

According to an exemplary embodiment of the invention there is disclosed a rodent control feed comprising the rodent control mixture being mixed with a plurality of rodent food.

According to an exemplary embodiment of the invention there is disclosed a method of utilizing the rodent control feed by placing an amount of the rodent control feed into a rodent hole.

According to an exemplary embodiment of the invention there is disclosed a method of manufacturing a rodent control mixture. The method includes blending a plurality of chewing gum to thereby form a blended chewing gum, mixing in a plurality of salt, mixing in a plurality of fast rising yeast, and mixing in a flavor additive.

According to an exemplary embodiment of the invention there is disclosed a method of manufacturing a rodent control feed. The method includes blending a plurality of chewing gum to thereby form a blended chewing gum, mixing in a plurality of salt, mixing in a plurality of fast rising yeast, mixing in a flavor additive, mixing in a plurality of hot water, mixing in a plurality of vegetable oil, and mixing in a plurality of rolled oats.

According to an exemplary embodiment of the invention there is disclosed a rodent control mixture safe to humans. The rodent control mixture includes a plurality of ingredients having relative weight ratios as follows: two weight units of a blended chewing gum; two weight units of common table salt; one weight unit of fast-rising yeast; and one weight unit of alfalfa powder. The blended chewing gum comprises a chewing gum blended into a powdered form and the ingredients of the rodent control mixture are free of Strychnine and further are free of any other rodent poison harmful to humans.

According to an exemplary embodiment of the invention there is disclosed a method of manufacturing a rodent control mixture safe to humans. The method includes combining a plurality of ingredients having relative weight ratios as follows: blending two weight units of a chewing gum into a powdered form to thereby form a blended chewing gum; mixing in two weight units of common table salt; mixing in one weight unit of fast-rising yeast; and mixing in one weight unit of alfalfa powder. The rodent control mixture is free of Strychnine and is further free of any other rodent poison harmful to humans.

According to an exemplary embodiment of the invention there is disclosed a method of manufacturing a rodent control feed safe to humans. The method includes combining a plurality of ingredients having relative weight ratios as follows: blending two ounces of a chewing gum into a powdered form to thereby form a blended chewing gum; mixing in two ounces of common table salt; mixing in one ounce of fast-rising yeast; mixing in one ounce of alfalfa powder; mixing in a gallon of rodent food; mixing in one metric cup of water heated to 80 deg C. or higher; and mixing in two ounces of vegetable oil. The rodent control feed is free of Strychnine and is further free of any other rodent poison harmful to humans.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 illustrates a method of manufacturing a rodent control mixture, a rodent control feed utilizing the mixture, and a method of utilizing said feed to control rodents according to an exemplary embodiment.

FIG. 2 illustrates a cross-sectional side-view of a portion of a gopher burrow to help show the usage method of FIG. 1 according to an exemplary embodiment.

### DETAILED DESCRIPTION

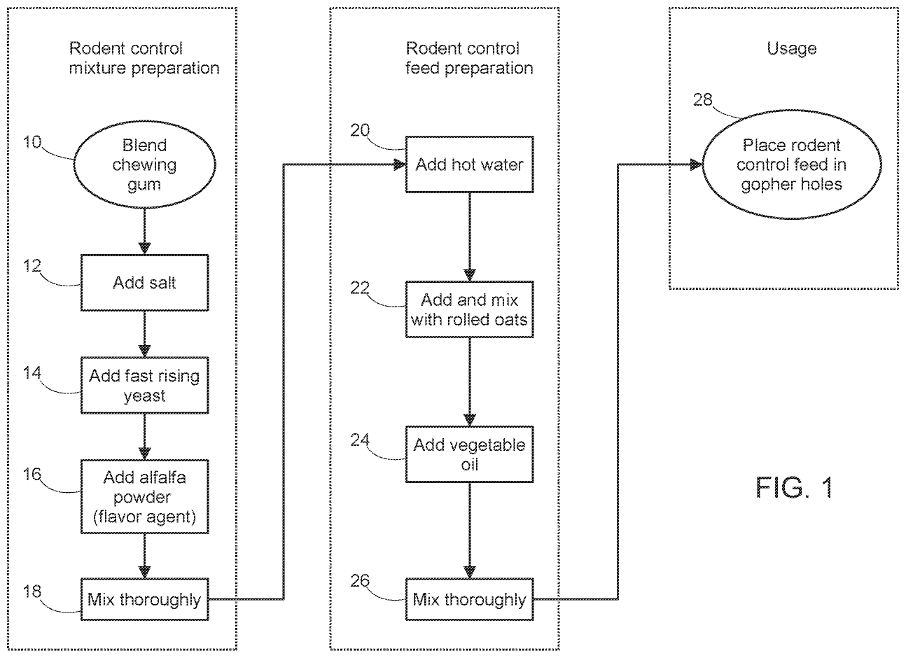

FIG. 1 illustrates a method of manufacturing a rodent control mixture, a rodent control feed utilizing the mixture, and a method of utilizing said feed to control rodents according to an exemplary embodiment. The steps of the flowchart are not restricted to the exact order shown, and, in other configurations, shown steps may be omitted or other intermediate steps added.

In this embodiment, the rodent to be controlled is assumed to be a gopher and the rodent control mixture includes:
two (2) ounces of blended chewing gum,
two (2) ounces of common table salt,
one (1) ounce of fast rising yeast, and
one (1) ounce of a flavor additive being alfalfa powder, which is a flavor enjoyed by gophers.

Preparation of the rodent control mixture involves the following steps.

At step 10, the blended chewing gum is formed by blending a Chiclets chewing gum such as Excel® brand spearmint flavored gum into a powdered form. The blending may be performed utilizing any suitable blending device such as a food processor or blender, for example. The salt, fast rising yeast and alfalfa powder are added (steps, 12, 14, 16, respectively). The combination of the above ingredients is then mixed thoroughly to form the rodent control mixture. In some embodiments, this rodent control mixture is manufactured by a rodent control vendor and sold in stores for consumers to purchase.

A next step of the process involves manufacturing a rodent control feed utilizing the above-described mixture. For example, in some embodiments, rodent control feed preparation is performed by the consumer after purchasing the rodent control mixture described above. At step 20, one metric cup (250 ml) of hot water (e.g., 80 deg C. or higher in some embodiments) is added to the rodent control mixture. The combination of the hot water and the rodent control mixture is then combined and mixed with a gallon of food that the gophers like to eat such as rolled oats (step 22). One ounce of vegetable oil is added to help hold the ingredients together (step 24) and then the combination is thoroughly mixed at step 26 to form the rodent control feed ready for application.

The usage of the rodent control feed at step 28 involves placing a portion of the rodent control feed such as 20-30 pieces of rolled oats in the various gopher holes throughout the field or other area where the rodents are to be controlled.

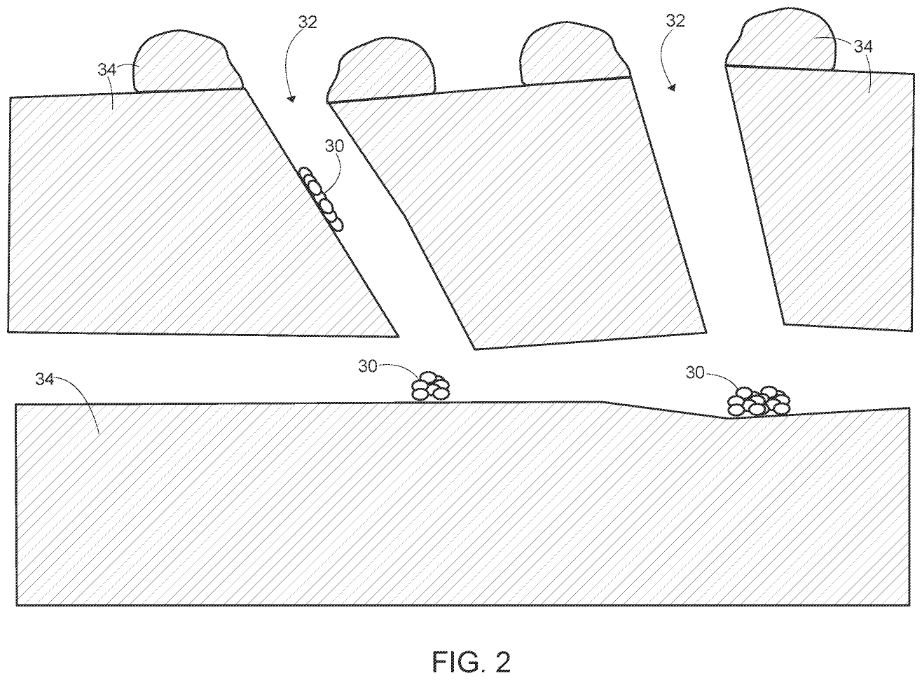

FIG. 2 illustrates a cross-sectional side-view of a portion of a gopher burrow to help show the usage method step 28 of FIG. 1 according to an exemplary embodiment. As illustrated, a portion of the gopher control feed 30 is placed into the gopher holes 32, where said holes 32 are dug into soil 34 by the gophers.

Placing the rodent control feed 30 into the holes 32 helps prevent cattle or other domesticated and wild animals from inadvertently finding and eating the feed 30. The gophers, however, find and eat the rodent control feed 30 and become sick from the ingredients.

Without full knowledge of the mechanism of action and without limiting to a specific mechanism of action, it is believed by the inventor that the smells of the chewing gum and flavor agent (e.g., spearmint and alfalfa) encourage the gophers to eat the feed 30 (i.e., rolled oats covered in the rodent control mixture). The blended chewing gum, salt and fast rising yeast thereafter bloat and gum up the digestive tract of the rodent thereby preventing the rodent from continuing to stay healthy and vital.

Experiments by the inventor have shown effectiveness of the rodent control mixture and feed 30 and associated methods disclosed herein. In a trial, the inventor applied the rodent control feed 30 to an estimated 2000 gopher holes in a 10-acre field. Prior to application, many hundreds of gophers were visible throughout the field at any given time. The inventor estimates 1-3 gophers were living per hole leading to approximately 2000-6000 gophers present in the field, of which many adults were visible from the surface at any given time. Over a month, the inventor placed rodent control feed 30 into approximately 200 holes at a time in a particular section of the field. Each subsequent day after application, the inventor noticed that the treated section of the field had noticeably fewer gophers visible. Approximately 200 holes in a different section of the field were then treated in a similar manner. After about a month of such application, the entirety of the field was finished being treated and only two gophers were observed in the entire field instead of hundreds as were observed prior to application.

Exemplary benefits of certain embodiments include that the rodent control mixture and associated feed 30 are manufactured with natural ingredients safe to humans and less harmful to other domesticated animals with larger stomachs and digestive systems such as cows and horses. Because the rodent control feed 30 disclosed herein does not immediately kill the rodents, the rodents have time to re-enter their burrows and generally do not come out again. Thus, hawks and other scavengers have reduced chance to catch and eat the sick gophers; instead, the gophers die in their burrows and decompose back into the soil.

Although the invention has been described in connection with preferred embodiments, it should be understood that various modifications, additions and alterations may be made to the invention by one skilled in the art without departing from the spirit and scope of the invention.

For example, although weight unites of ounces were utilized above, in some embodiments, the relative weights of ingredients utilizing different weight units such as grams or even kilograms are possible in the same weight ratios of ingredients. For example, in some embodiments, the rodent control feed 30 includes two weight units of the powdered gum, two weight units of the salt, one weight unit of the fast-rising yeast, and one weight unit of the flavor additive.

Although the chewing gum found to work well by the inventor and described above was spearmint flavored sugar-free Excel®-brand Chiclets blended into a powder, other types and flavors of chewing gum may be utilized in a similar manner in different embodiments. Likewise, although the flavor additive found to work well by the inventor and described above was alfalfa powder, other types of flavor additives may be utilized in a similar manner.

The fast rising yeast may also be called quick rise or instant yeast when purchased in grocery stores—it looks like its active dry counterpart, but the granules are smaller and it activates much more quickly. It is sometimes advertised as being good for quick baking projects because it allows making bread with just one rise.

The rodent control feed 30 is formed by mixing the rodent control mixture (of step 18) with a rodent food. Although the rodent food was described above as being a gallon of rolled oats, which are particularly enjoyed by gophers, other amounts and types of rodent food such as grain may be utilized in a similar manner.

Likewise, although the target rodent for which the mixture was found to control well were gophers and the rodent control feed 30 was described above as being placed into gopher holes 32, other small rodents such as mice and rats may also be treated in a similar manner. Given the success of the control of gophers, the inventor predicts the treatment will be effective for controlling other types of small rodents in a similar manner.

All combinations and permutations of the above-described features and embodiments may be utilized in conjunction with the invention.

What is claimed is:

1. A rodent control mixture safe to humans, the rodent control mixture comprising a plurality of ingredients having relative weight ratios as follows:
two weight units of a blended chewing gum;
two weight units of common table salt;
one weight unit of fast-rising yeast; and
one weight unit of alfalfa powder;
wherein the blended chewing gum comprises a chewing gum blended into a powdered form; and
the ingredients of the rodent control mixture are free of Strychnine and further are free of any other rodent poison harmful to humans.

2. The rodent control mixture of claim 1, wherein the chewing gum comprises a Chiclets chewing gum.

3. The rodent control mixture of claim 2, wherein the Chiclets chewing gum is Excel® brand.

4. The rodent control mixture of claim 1, wherein the blended chewing gum is spearmint flavored.

5. The rodent control mixture of claim 1, wherein the weight units are ounces.

6. A rodent control feed comprising the rodent control mixture of claim 5 being mixed with a gallon of rodent food.

7. The rodent control feed of claim 6, wherein the rodent food comprises rolled oats.

8. The rodent control feed of claim 6, wherein the rodent control mixture is further mixed with one metric cup of water heated to 80 deg C. or higher.

9. The rodent control feed of claim 6, wherein the rodent control mixture is further mixed with two ounces of vegetable oil.

10. A method of utilizing the rodent control feed of claim 6, the method comprising placing an amount of the rodent control feed into a rodent hole.

11. The method of claim 10, wherein the rodent hole is a gopher hole.

12. A method of manufacturing a rodent control mixture safe to humans, the method comprising combining a plurality of ingredients having relative weight ratios as follows:
blending two weight units of a chewing gum into a powdered form to thereby form a blended chewing gum;
mixing in two weight units of common table salt;
mixing in one weight unit of fast-rising yeast; and
mixing in one weight unit of alfalfa powder;
wherein the rodent control mixture is free of Strychnine and is further free of any other rodent poison harmful to humans.

13. The method of claim 12, wherein the weight units are ounces.

14. The method of claim 12, wherein the chewing gum is a Chiclets chewing gum.

15. The method of claim 12, wherein the chewing gum is spearmint flavored.

16. A method of manufacturing a rodent control feed safe to humans, the method comprising combining a plurality of ingredients having relative weight ratios as follows:
blending two ounces of a chewing gum into a powdered form to thereby form a blended chewing gum;
mixing in two ounces of common table salt;
mixing in one ounce of fast-rising yeast;
mixing in one ounce of alfalfa powder;
mixing in a gallon of rodent food;
mixing in one metric cup of water heated to 80 deg C. or higher; and
mixing in two ounces of vegetable oil;
wherein the rodent control feed is free of Strychnine and is further free of any other rodent poison harmful to humans.

17. The method of claim 16, wherein the rodent food comprises rolled oats.

18. The method of claim 16, wherein the chewing gum is a Chiclets chewing gum.

19. The method of claim 18, wherein the Chiclets chewing gum is Excel® brand.

20. The method of claim 16, wherein the chewing gum is spearmint flavored.
